(19) United States
(12) Patent Application Publication
(10) Pub. No.: US 2008/0152318 A1
(43) Pub. Date: Jun. 26, 2008

(54) OPTICAL-DISC RECORDING/PLAYBACK APPARATUS AND OPTICAL-DISC RECORDING/PLAYBACK METHOD

(75) Inventors: Yukiyasu TATSUZAWA, Yokohama-Shi (JP); Hideyuki YAMAKAWA, Kawasaki-Shi (JP); Koichi OTAKE, Yokohama-Shi (JP); Toshihiko KANESHIGE, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/959,125

(22) Filed: Dec. 18, 2007

(30) Foreign Application Priority Data
Dec. 26, 2006 (JP) 2006-350274

(51) Int. Cl. H04N 7/26

(52) U.S. Cl. 386/124; 386/E05.001

(57) ABSTRACT

An optical-disc recording/playback apparatus performs recording/playback to/from an optical-disc having a data area serving as a recordable area and a header area in which address information of the data area is pre-recorded by embossing. The apparatus includes an area determining unit for determining the data area and the header area based on a playback signal from the optical-disc, an AD converter for converting the playback signal from an analog signal to a digital signal, and a playback decoding unit for reading information of the data area and the header area from the digital signal output from the AD converter. During playback of the data area, the playback decoding unit performs first playback decoding processing. During playback of the header area, the playback decoding unit performs second playback decoding processing without making changes to a basic configuration of the playback decoding unit.

### CROSS-REFERENCE TO RELATED APPLICATIONS

This application claims the benefit of priority of Japanese Patent Application No. 2006-350274, filed Dec. 26, 2006, the entire contents of which are incorporated herein by reference.

### BACKGROUND

1. Field

The present invention relates to optical-disc recording/playback methods and optical-disc recording/playback apparatuses. In particular, the present invention relates to an optical-disc recording apparatus and an optical-disc recording method which use a PRML system.

2. Description of the Related Art

In recent years, HD (high definition) DVD players and recorders based on large-capacity optical-disc standards, which are aimed to play back HD video, have been coming to the market. The HD DVDs employ a blue-violet laser having a wavelength of 405 nm to perform recording/playback, and a read-only HD DVD-ROM standard has a recording capacity of 15 GB with a one-sided single layer and a recording capacity of 30 GB with one-sided two layers.

Write-once HD DVD-Rs also have a recording capacity of 15 G with one layer and a recording capacity of 30 GB with two layers. Rewritable HD DVD-RAMs have a recording capacity of as much as 20 GB with only one layer.

In order to achieve the large capacity, the HD DVD standard employs not only a system for reducing the laser wavelength but also a PRML (Partial Response and Maximum Likelihood) system for processing signals during data playback. The PRML technology, which is a well-known technology, will be briefly described below.

The partial response (PR) system plays back data while compressing a required signal bandwidth by utilizing intersymbol interference (i.e., interference between playback signals corresponding to adjacently recorded bits). Partial response (PR) can further be classified into multiple classes, depending on the way of generation of the intersymbol interference. For example, for class 1, recorded “1” is played back as 2-bit playback data “11”, and intersymbol interference is generated for the subsequent 1 bit.

On the other hand, ML (maximum likelihood) is one type of the so-called “maximum likelihood sequence estimation”, and effectively utilizes the regulation of intersymbol interference in a playback waveform to perform data playback based on information of signal amplitudes at multiple points of time. A Viterbi decoding system is often used for the maximum likelihood sequence estimation.

A synchronization clock that is synchronous with a playback waveform obtained from an optical-disc is generated, and based on the clock, the playback waveform is sampled and is converted into amplitude information. Thereafter, the amplitude information is subjected to appropriate waveform equalization and is converted into a predetermined partial response waveform. A Viterbi decoding unit uses past and present sample data to output a most-likely data series as playback data.

Such a combination of the partial response system and the Viterbi decoding (maximum likelihood decoding) system is called the “PRML system”. Practical application of the PRML system requires a high-precision adaptive equalization technology that causes the playback signal to have an intended PR-class response and a high-accuracy clock playback technology that supports the equalization technology.

A description is now given of run-length limited code used in the PRML system. In a playback circuit using the PRML system, for example, based on a signal played back from an optical-disc, a reference clock that is synchronous with the playback signal is generated by the use of, for example, a PLL circuit. In order to generate a stable clock, the polarity of the recording signal needs to be reversed within a predetermined period of time. On the other hand, in order to reduce the maximum frequency of the recording signal, it is also necessary to ensure that the polarity of the recording signal is not reversed during a predetermined period of time. In this case, a maximum data length with which the polarity of the recording signal is not reversed is called a maximum run-length, and a minimum data length at which the polarity is not reversed is called a minimum run-length.

For example, a modulation regulation in which the maximum run-length is 7 bits and the minimum run-length is 1 bit is called RLL (1, 7), which is generally referred to as “2T code” since minimum mark-length or space-length Tmin is 2T. Further, a modulation regulation in which the maximum run-length is 7 bits and the minimum run-length is 2 bits is called RLL (2, 7), and is similarly referred to as “3T code”, since minimum mark-length or space-length Tmin is 3T.

Typical modulation/demodulation systems used for optical-discs include 2T-code-based ETM (Eight to Twelve Modulation), which is employed for HD DVDs, and 3T-code-based 8/16 modulation (EEM Plus) employed for conventional DVDs.

As described above, it is expected that the recording/playback apparatus using the PRML system offers a significant performance improvement to high-density recording optical-discs, for which it is difficult for the known binary slice system to provide sufficient playback performance. Thus, the HD DVD standard employs the PRML system to achieve a high linear recording density.

The playback of recorded data based on the PRML system is also applicable to conventional DVDs using a red laser. In particular, the merits of the PRML technique for adaptively processing signals can be fully utilized for disks whose signal qualities vary depending on the recording conditions and so on, such as recordable disks.

In a DVD-RAM, which is a typical example of the recordable DVDs, a special header area called a CAPA (complementary allocated pit address) area (hereinafter simply referred to as a “header area”) is provided in each divided user data block (hereinafter referred to as a “data area”. Physical address information is pre-recorded in the header area as embossed information to enable random access during recording. The data recording format of the header area and the recording format of the data area differ greatly from each other, and thus, the quality of playback signals of the header area and the quality of playback signals of the data area also vary greatly from each other.

JP-A 2002-8315 discloses a technology aimed to reproduce playback signals of those two types of areas by using the PRML system. In this technology, for example, coefficients used for a digital filter for waveform equalization are switched with respect to the two types of playback signals.

However, the use of the PRML system to play back both the header area and the data area has a problem due to reasons as follows.

A first reason is that periodic signals called “VFO (variable frequency oscillator) signals” that exist in the header area accounts for more than 65% of the entire area of the header area. Adaptive equalization processing required in the PRML system has a diverging characteristic when learning is performed with periodic data. Thus, it is technically difficult to perform adaptive equalization processing on the playback signals of the header area.

A second reason is that two areas constituting the header area (the two areas will hereinafter be referred to as a “header-1 area” and a “header-2 area”) are arranged in a zigzag pattern in which they are shifted from each other in opposite directions relative to the center line of a track in the data area. Thus, when a laser-light beam spot that is playing back a track in the data area enters the header area, the amplitude of the playback signals from the header-1 area and the amplitude of the playback signals from the header-2 area can greatly different from each other. This amplitude difference brings about a disorder in the amplitude in playing back the header area. The PRML system has difficulty in dealing with a disorder in the amplitude information and also has a possibility to output playback data of a wrong header area.

A third reason is that optical nonlinearity can be superimposed on playback signals since reflection light from the header-1 area and reflection light from the header-2 area are incident on an optical system from different positions from each other. This also makes it difficult for the PRML system to play back the header area.

### SUMMARY OF THE INVENTION

The present invention has been made in view of the foregoing situations, and an object of the present invention is to provide an optical-disc recording/playback apparatus and an optical-disc recording/playback method which are used for an optical-disc having a data area serving as a recordable area and a header area in which the address information of the data area is pre-recorded by embossing and which allow both data recorded in the data area and data recorded in the header area to be played back with high quality, without making changes to the basic configuration.

In order to overcome the above-described problems, an aspect of the present invention provides an optical-disc recording/playback apparatus for performing recording/playback to/from an optical-disc having a data area serving as a recordable area and a header area in which address information of the data area is pre-recorded by embossing. The optical-disc recording/playback apparatus includes an area determining unit for determining the data area and the header area based on a playback signal from the optical-disc, an AD converter for converting the playback signal from an analog signal to a digital signal, a playback decoding unit for reading information of the data area and the header area from the digital signal output from the AD converter. During playback of the data area, the playback decoding unit performs first playback decoding processing. During playback of the header area, the playback decoding unit performs second playback decoding processing without making changes to a basic configuration of the playback decoding unit.

In order to overcome the above-described problems, another aspect of the present invention provides an optical-disc recording/playback method for performing recording/playback to/from an optical-disc having a data area serving as a recordable area and a header area in which address information of the data area is pre-recorded by embossing. The optical-disc recording/playback method includes the steps of (a) determining the data area and the header area based on a playback signal from the optical-disc, (b) converting the playback signal from an analog signal to a digital signal, and (c) reading information of the data area and the header area from the digital signal converted in step (b). In step (c), during playback of the data area, playback based on a PRML system is performed, and during playback of the header area, playback based on a digital slice system is performed.

In the optical-disc recording/playback apparatus and the optical-disc recording/playback method according to the above aspects of the present invention, with respect to an optical-disc having a data area serving as a recordable area and a header area in which the address information of the data area is pre-recorded by embossing, both data recorded in the data area and data recorded in the header area can be played back with high quality, without making changes to the basic configuration.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing the physical structure of a DVD-RAM;

FIG. 2 is a diagram schematically showing the data structure of the DVD-RAM;

FIG. 3 schematically shows signal strengths of playback signals of the DVD-RAM;

FIG. 4 is an example of the configuration of an optical-disc recording/playback apparatus according to one embodiment of the present invention;

FIG. 5 is a diagram illustrating an operation principle of an adaptive equalizer;

FIG. 6 shows one example of various switching signals based on detection of a header area;

FIG. 7 is a diagram showing an example of a detailed configuration of an offset control circuit and illustrating changing of a filter value of a control filter;

FIG. 8 is a diagram showing an example of a detailed configuration of an asymmetry control circuit and illustrating changing of a filter value of a control filter;

FIG. 9 is a diagram showing an example of a detailed configuration of a limit-equalizer/adaptive equalizer and illustrating switching between playback decoding processing for the header area and playback decoding processing for the data area;

FIG. 10 illustrates a jitter-reduction effect of a limit equalizer;

FIG. 11 is an example of a configuration when a slicer/viterbi decoder is caused to function as a digital slicer having a correction function based on run-length limitation;

FIG. 12 illustrates the correction function based on the run-length limitation; and

FIGS. 13A and 13B illustrate a half-clock shift between sampling points of a PRML system and sampling points of a digital slice system.

### DETAILED DESCRIPTION

An optical-disc recording/playback apparatus and an optical-disc recording/playback method according to one embodiment of the present invention will be described below with reference to the accompanying drawings.

### 1) Overview of Optical-Disc

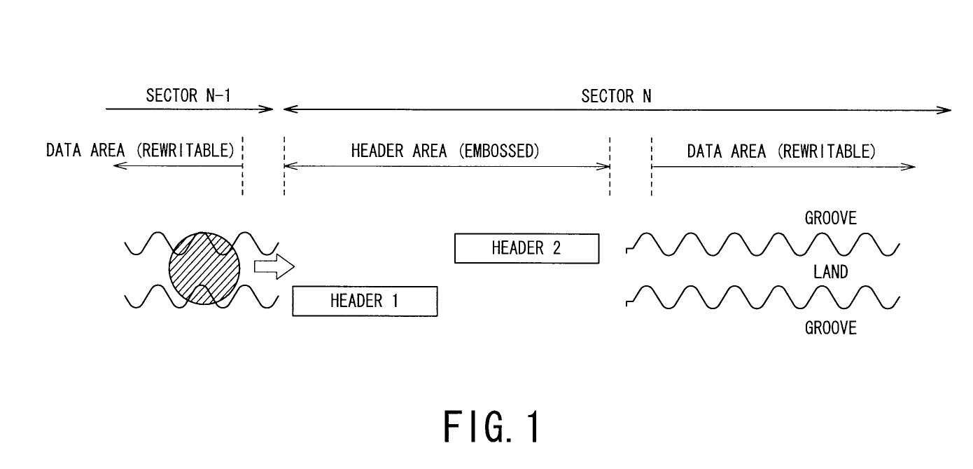

FIG. 1 is a diagram showing the physical structure of a DVD-RAM, which is a typical example of an optical-disc 100 to/from which an optical-disc recording/playback apparatus 1 according to this embodiment performs recording/playback.

The optical-disc 100 is divided into blocks called sectors, each having a data area serving as a recordable area and a header area in which address information of the data area is pre-recorded by embossing.

The data area is a writable area using phase changes, and data can be recorded to and played back from both lands and grooves. The data area has wobbles.

The header area, on the other hand, is an area in which physical address information is pre-recorded by embossing before the shipment of the optical-disc 100. The header area includes two areas, that is, a header-1 area and a header-2 area. The header-1 area and the header-2 area are arranged in a zigzag pattern in which they are shifted from each other in opposite directions relative to the center line of a track (a land or grooves) in the data area.

The data of the header area is recorded on embossed pits, and this recording format is greatly different from the recording format of the data area using phase changes.

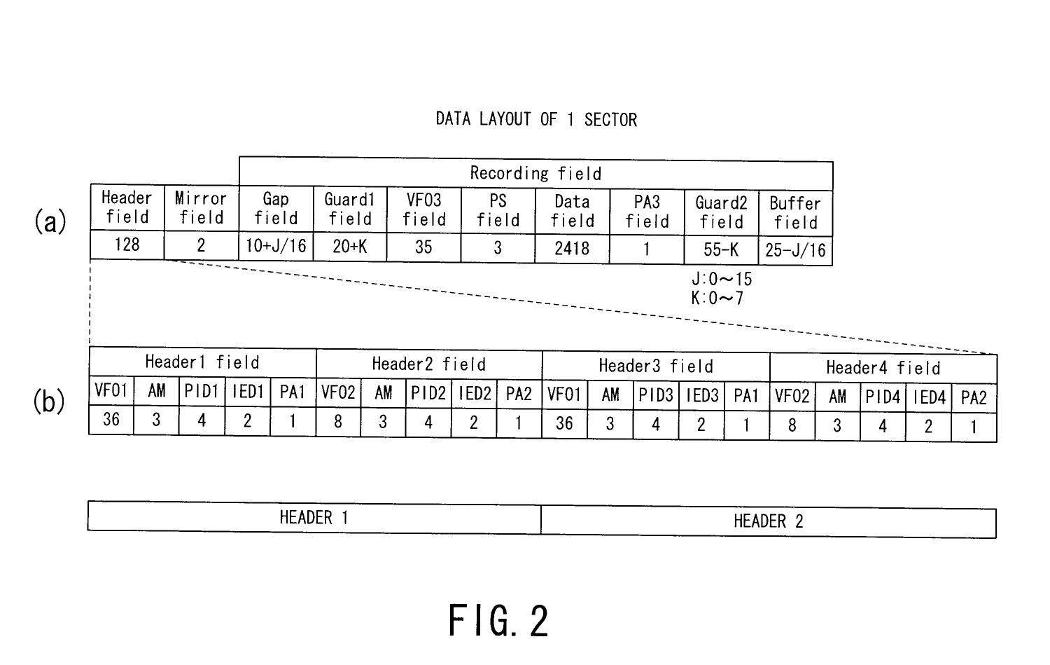

Part (a) of FIG. 2 shows the data structure of one sector and part (b) of FIG. 2 shows the data structure of a header field located at the head of the sector. A header-1 area has a header-1 field and a header-2 field, and a header-2 area has a header-3 field and a header-4 field. Each header field has recorded data called VFO (variable frequency oscillator), AM (address mark), PID (physical ID), IED, and PA. The PID is data indicating a physical address.

As shown in part (b) of FIG. 2, of the header area, the VFO area occupies the largest area, which accounts for more than 65% of the entire header area.

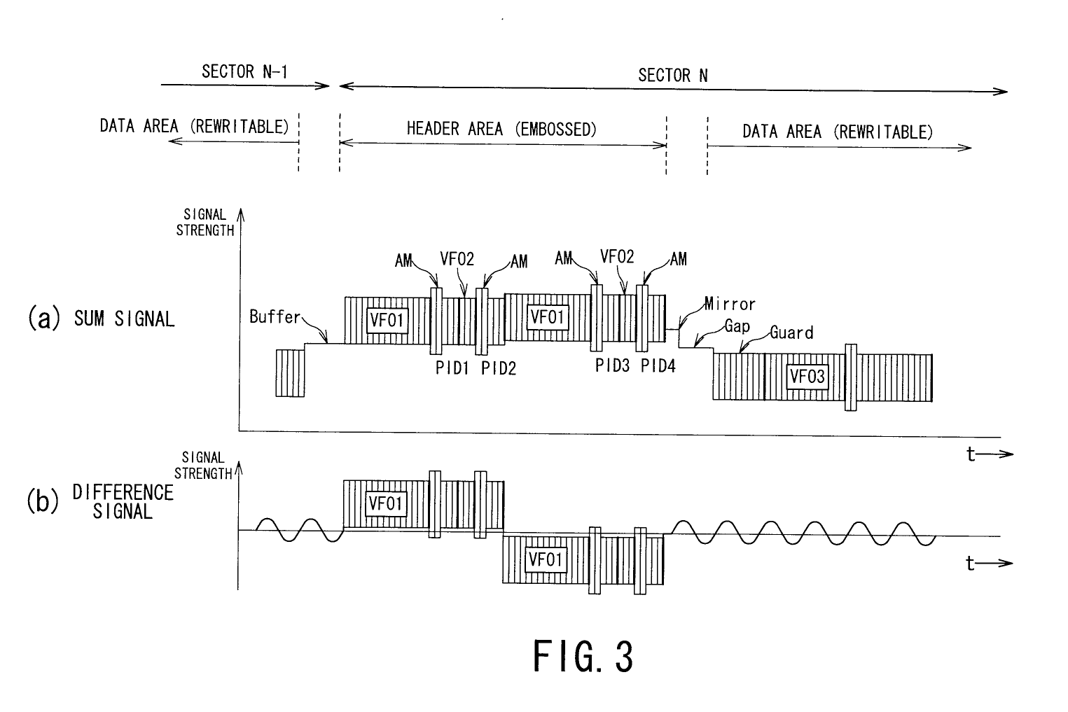

FIG. 3 schematically shows the strength of playback signals of the header area and the data area. More specifically, part (a) of FIG. 3 illustrates sum signals and part (b) of FIG. 3 illustrates difference signals mainly used for tracking servo control.

As described above, the recording format of the header area and the recording format of the data area differ greatly from each other, and the strengths of the playback signals thereof also greatly vary from each other. Since the header-1 area and the header-2 area are arranged in a zigzag pattern, the polarity is reversed for the difference signals and nonlinearity may occur for the sum signals. In addition, during playback of the header area, the tracking servo is turned off and the operation enters a free-run state. Thus, when the beam spot is displaced from the center line by drifting, the signal strengths of even the sum signals of the header-1 area and the header-2 area may also be greatly different from each other.

Thus, the playback signals of the header area have many factors for variations in the signal amplitude, and moreover, as described, the majority of the header area is occupied by the VFO areas containing periodic signals. The PRML system is, therefore, not suitable for the playback of the header area.

Accordingly, in the optical-disc recording/playback apparatus 1 according to the present embodiment, a digital slice system that is resistant to variations in the signal amplitude and that allows periodic signals to be played back and decoded without any problem is employed for the header area, and the PRML system that allows playback to be performed with high quality is employed for the data area.

Playback decoding processing based on the digital slice system and playback decoding processing based on the PRML system are achieved by substantially the same circuit configuration, to thereby prevent the system scale from becoming large.

The digital slice system and the PRML system are switched by a method, such as switching of some signal paths and changing of a filter value. Naturally, the switching is performed instantaneously (in real time).

### 2) Basic Configuration and Basic Operation of Optical-Disc Recording/Playback Apparatus

Before a description is given of switching between the PRML system and the digital slice system, the basic configuration and operation of the optical-disc recording/playback apparatus 1 will now be described based on playback using the PRML system.

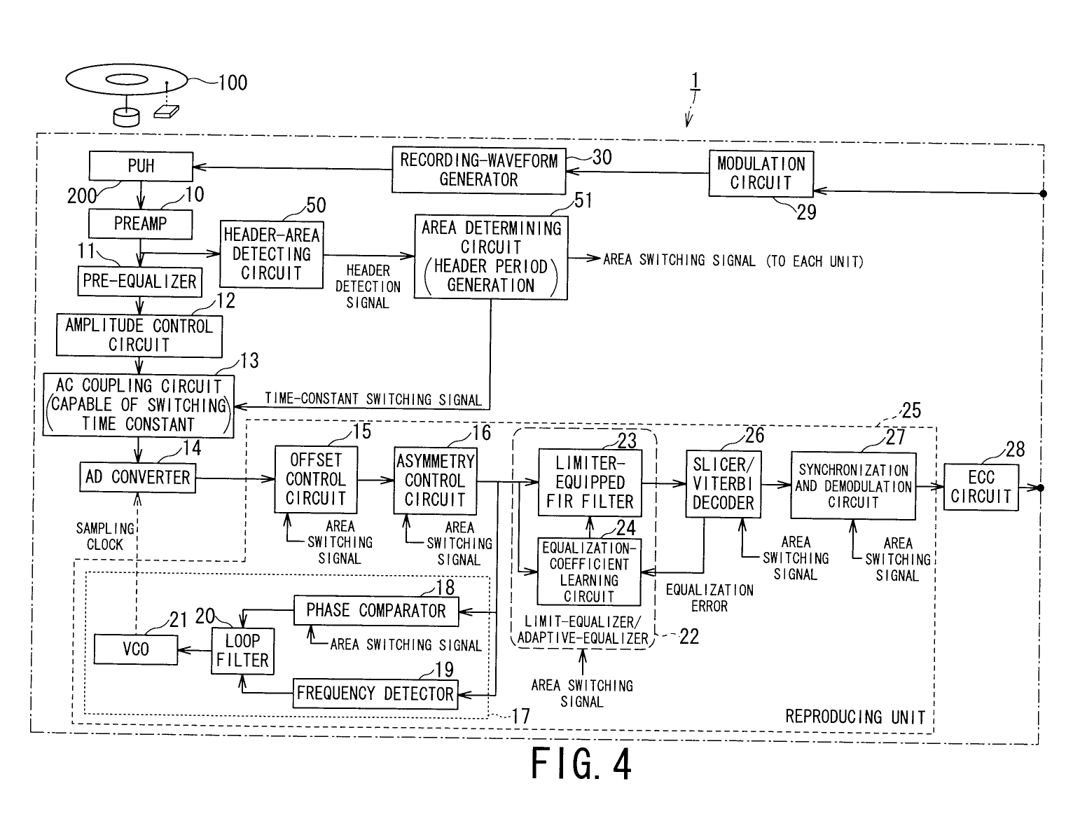

FIG. 4 is a block diagram showing an example of the configuration of the optical-disc recording/playback apparatus 1 according to the embodiment of the present invention. The optical-disc recording/playback apparatus 1 generally includes a playback section for play backing data recorded on the optical-disc 100, a recording section for recoding data to the optical-disc 100, and a header-area detecting section.

The playback section includes a PUH (pick-up head) 200, a pre-amplifier 10, a pre-equalizer 11, an amplitude control circuit 12, an AC coupling circuit 13, an AD converter 14, a playback decoding unit 25, and an ECC circuit 28.

The playback decoding unit 25 has therein an offset control circuit 15, an asymmetry control circuit 16, a PLL unit 17, a limit-equalizer/adaptive-equalizer 22, a slicer/viterbi decoder 26, and a synchronization and demodulation circuit 27.

The PLL unit 17 has therein a phase comparator 18, a frequency detector 19, a loop filter 20, and a VCO 21.

The limit-equalizer/adaptive-equalizer 22 has therein a limiter-equipped FIR filter 23 and an equalization-coefficient learning circuit 24.

The recording section has a modulation circuit 29 and a recording-waveform generator 30.

The header-area detecting section has a header-area detecting circuit 50 and an area determining circuit 51.

The basic operation of the optical-disc recording/playback apparatus 1 configured as described above will be described starting from the playback section.

The PUH 200 has a built-in laser device (not shown) to illuminate the optical-disc 100 with laser light at a laser power for playback, detects reflection light from the optical-disc 10, and outputs a playback signal.

The playback signal output from the PUH 200 is sent to the pre-amplifier 10, is subjected to processing, such as signal amplification, and is then subjected to preliminary waveform equalization by the pre-equalizer 11. The equalization configuration may be realized by, for example, an equiripple filter.

Subsequently, the amplitude of the signal subjected to the waveform equalization processing is adjusted by the amplitude control circuit 12, and the resulting signal is input to the AC coupling circuit 13. The AC coupling circuit 13 uses a filter having a predetermined time constant to perform AC coupling to eliminate DC components. An analog playback signal is output from the AC coupling circuit 13 and is converted by the AD converter 14 into digital values.

A sampling clock for the AD converter 14 is extracted from the playback signal so that the sampling timing becomes appropriate. That is, the frequency detector 19 detects a channel frequency from the playback waveform and the phase comparator 18 detects and controls a phase difference relative to an ideal sampling point.

The PLL unit 17 is a unit generally referred to as a PLL (Phase Locked Loop). The single loop filter 20 is used to control both the frequency and the phase, and the VCO (voltage controlled oscillator) 21 supplies a clock to the AD converter 14.

Since a clock for recording must be generated when the optical-disc 100 is a recordable medium such as a DVD-RAM, a meandering shape, called a wobble, is formed in a disk groove of the data area (see FIG. 1). Since the wobble frequency and the channel frequency are designed to have a certain ratio, wobble signals can be used to control the frequency alone without performing extraction from the playback signal.

The playback signal AD-converted by the AD converter 14 is subjected to digital waveform shaping by the offset control circuit 15 and the asymmetry control circuit 16.

The offset control circuit 15 controls the amount of offset of the playback signal so that, for example, the duty ratio of signal components becomes constant. The asymmetry control circuit 16 performs, for example, average-value detection on the offset-adjusted playback signal to detect asymmetry in a signal-amplitude direction and performs controls so that the playback signal has a symmetric waveform relative to the center value.

The playback signal subjected to the digital waveform shaping is then input to the limit-equalizer/adaptive-equalizer 22 and is subjected to waveform equalization processing so that the playback signal has a response waveform corresponding to a partial response (PR). The waveform equalization processing is performed by the FIR filter 23, which has a predetermined number of taps, but a tap coefficient used by the FIR filter 23 is generated by the equalization-coefficient learning circuit 24.

The structure and the operation of the limit-equalizer/adaptive-equalizer 22 (in this case, the structure and the operation thereof serving as an adaptive equalizer) are known, and an operation using the most typical LMS (least mean square) algorism will be described below.

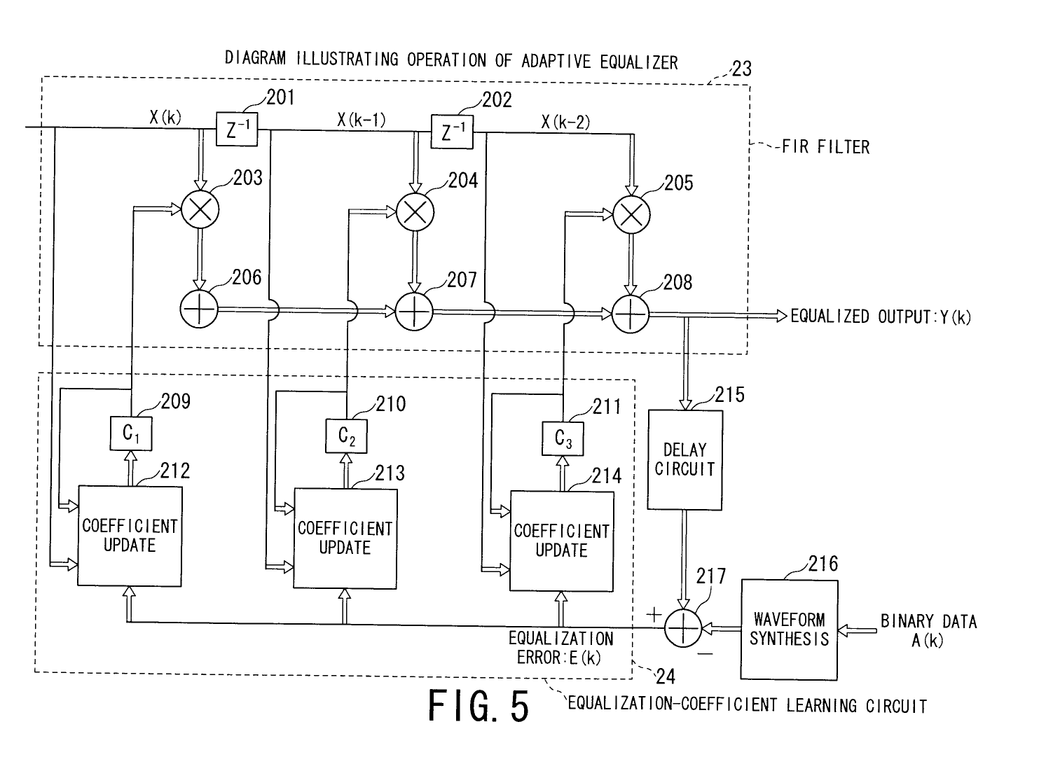

FIG. 5 is a block diagram showing an example of a detailed configuration of the limit-equalizer/adaptive-equalizer 22, which includes the FIR filter 23 and the equalization-coefficient learning circuit 24. For convenience of description, FIG. 5 also shows part of internal processing (equalization-error generation) of the slicer/viterbi decoder 26.

The limit-equalizer/adaptive-equalizer 22 according to the present invention uses both processing based on the digital slice system and processing based on the PRML system, and thus has a configuration modified to an inverted filter, instead of the configuration of the FIR filter 23 shown in FIG. 5. However, the commonly known (standard) configuration shown in FIG. 5 is used in the description of the following basic operation.

The FIR filter 23 includes clock delay units 201 and 202, multipliers 203, 204, and 205, and adders 206, 207, and 208. The clock delay units 201 and 202 are implemented with, for example, flip flops. The FIR filter 23 shown in FIG. 5 has a three-tap configuration using the three multipliers, but the number of taps is not particularly limited thereto. A description below will be given using the three-tap configuration, since the basic operations are the same even for an increased number of taps.

An output Y(k) of the limit-equalizer/adaptive-equalizer 22 can be expressed by:

Y(k)=x(k)*c1+x(k−1)*c2+x(k−2)*c3 (1)

where x(k) indicates a signal input to the limit-equalizer/adaptive-equalizer 22 (the FIR filter 23) at time k, and c1, c2, and c3 indicate multiplier factors input to the corresponding multipliers 203, 204, and 205.

Let A(k) be binary data obtained by the slicer/viterbi decoder 26, as opposed to Y(k). When the intended PR class is assumed to be, for example, PR(3443) and A(k) is assumed to be correct playback data, an output Z(k) of the limit-equalizer/adaptive-equalizer 22 at time k is expressed by:

Z(k)=3*A(k)+4*A(k−1)+4*A(k−2)+3*A(k−3)−7 (2)

Therefore, equalization error E(k) at time k is defined by:

E(k)=Y(k)−Z(k) (3)

The equalization error E(k) is input to the equalization-coefficient learning circuit 24, which then adaptively learns the coefficients c1, c2, and c3 of the multipliers 203, 204, and 205.

c1(k+1)=c1(k)−α*x(k)*E(k) (4)

c2(k+1)=c2(k)−α*x(k−1)*E(k) (5)

c3(k+1)=c3(k)−α*x(k−2)*E(k) (6)

where α in equations (4) to (6) is an update coefficient and is set to a small positive value, for example, 0.01. In the initial stage of the learning, the value of α is set to a large value, and after a certain period of time passes, the value of α is reduced. When α is large, a malfunction can occur due to noise and the α needs to be reduced to an appropriate value in order to reduce the error rate.

In FIG. 5, the waveform synthesis circuit 216 performs processing expressed by equation (2) noted above. The delay circuit 215 performs delay processing on the output Y(k) of the adder circuit 208, the delay processing corresponds to the time of processing performed by the viterbi decoder 26. Further an adder circuit 217 performs processing expressed by equation (3) noted above.

Coefficient updating circuits 212, 213, and 214 of the equalization-coefficient learning circuit 24 performs computations expressed by equations (4), (5), and (6), respectively, to update the coefficients c1, c2, and c3 of the multipliers 203, 204, and 205. Registers 209, 210, and 211 temporarily store the coefficients c1, c2, and c3, respectively.

Lastly, the slicer/viterbi decoder 26 performs maximum likelihood sequence estimation (Viterbi decoding) corresponding to a PR class on the playback signal shaped by the above-described learning processing and passed through the FIR filter 23 (i.e., the signal adaptively-equalized to the PR class), to thereby provide binary decoded data (binary data).

The binary data output from the slicer/viterbi decoder 26 is then input to the synchronization and demodulation circuit 27. In known DVDs including DVD-RAMs, a binary-data string is recorded as a unit of 1488-bit data called a frame. A synchronization unit in the synchronization and demodulation circuit 27 detects a 32-bit binary data string (SYNC code) indicating the start position of each frame and generates a 16-bit synchronization signal for a subsequent demodulation unit in the synchronization and demodulation circuit 27.

Subsequently, the demodulation unit in the synchronization and demodulation circuit 27 performs processing for demodulating binary data for 16 bits into 8-bit playback data in accordance with a predetermined demodulation regulation. Further, the resulting byte-data signal (i.e., demodulation data) is input to the ECC circuit 28.

The ECC circuit 28 performs error-correction processing for correcting an error resulting from a defect. The error-corrected playback data is output to external host equipment, such as a personal computer.

An overview of the operation of the recording section will now be described. Recording data output from the external host equipment is code-modulated by the modulation circuit 29 into code for recording. The code-modulated data string for recording is input to the recording-waveform generator 30. The recording-waveform generator 30 generates a recording waveform for a laser diode (laser device) driver (LDD). The recording waveform is used to record data to the data area of the optical-disc 100.

### 2) Determination of Header Area and Data Area

Switching between the playback decoding processing for the header area and the playback decoding processing for the data area requires detection of the header area. The detection is performed by the header-area detecting circuit 50.

As can be seen from FIG. 3, large DC steps exist between the header area and the other areas. The header-area detecting circuit 50 detects the DC steps from the sum signal output from the PUH 200 (i.e., the signal output from the pre-amplifier 10) and generates a header-area detection signal. The header-area detecting circuit 50 may use the difference signal to detect a DC step between the header 1 and the header 2.

Based on the header-area detection signal generated by the header-area detecting circuit 50, the area determining circuit 51 generates various timing signals for switching between the processing for the header area and the processing for the data area.

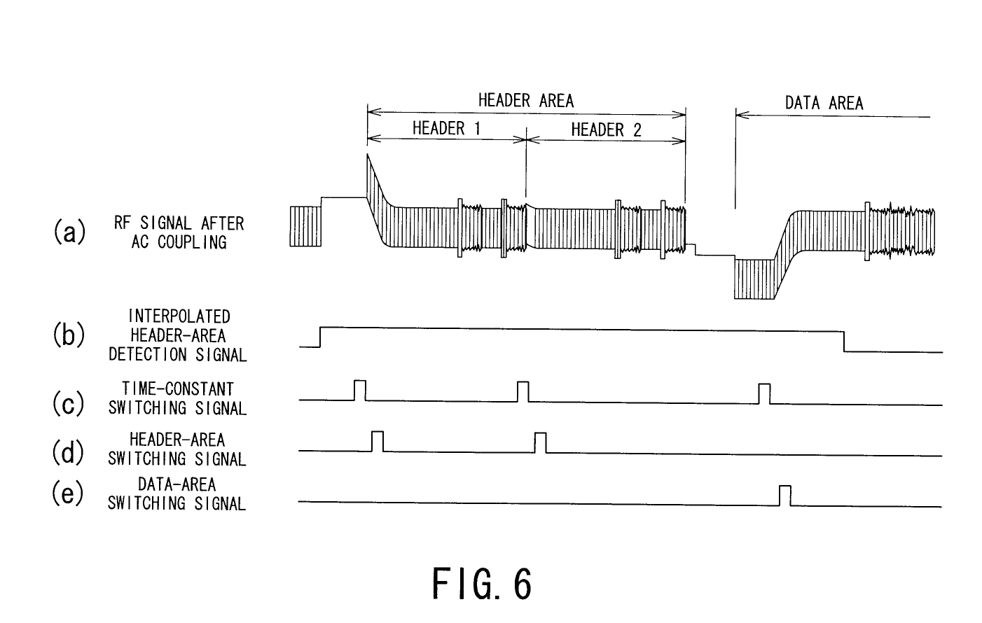

FIG. 6 illustrates the timing signals generated by the area determining circuit 51.

The area determining circuit 51 first generates an interpolated header-area detection signal. The interpolated header-area detection signal is generated by the so-called “flywheel counter”. The flywheel counter measures a time interval between headers and estimates the timing of arrival of a next header-area detection signal based on the measured time interval to generate a gate waveform. Because of the estimated gate, it is possible to reserve a larger length than the length of the actual header area, as shown in part (b) of FIG. 6. Even when the header-area detection signal cannot be temporarily detected, the interpolated header-area detection signal can be output for a certain period of time. When the position of the interpolated header-area detection signal and the position of an actually detected header-area detection signal are different from each other, the position of the interpolated header-area detection signal may be corrected.

The area determining circuit 51 generates a three-pulse time-constant switching signal (see part (c) of FIG. 6), which is delayed by a predetermined time relative to the rising of the interpolated header-area detection signal.

For the playback signal, large DC steps are generated at two portions, i.e., the head of the header area and the head of the data area. Also, during the shift from the header-1 area to the header-2 area, a DC step may be generated.

As described above, in the AC coupling circuit 13, the AC coupling filter having a predetermined time constant eliminates DC components. When a large DC step is input to the AC coupling filter, it is necessary to quickly absorb the DC step. Thus, it is preferable to reduce the time constant (i.e., increase the response speed) of the AC coupling filter. On the other hand, after convergence, it is preferable to increase the time constant (i.e., reduce the response speed) of the AC coupling filter from the viewpoint of noise reduction. Thus, when a large DC step is generated, it is preferable to switch the time constant of the AC coupling filter between multiple steps, for example, three steps of high speed, medium speed, and low speed. A time-constant switching signal provides the AC coupling circuit 13 with timing for performing the time-constant switching. Controlling such switching of the time constant allows the DC steps in the output waveform (part (a) of FIG. 6)of the AC coupling circuit 13 to be smoothly absorbed in a short period of time.

The area determining circuit 51 generates three area-switching signals with a predetermined amount of time delay relative to the rising of the interpolated header-area detection signal. In this case, the first and second signals are used as header-area switching signals (part (d) of FIG. 6) and the third signal is used as a data-area switching signal (part (e) of FIG. 6). Those signals are combined into an area switching signal, which is sent to the individual blocks shown in FIG. 4. This area switching signal allows the individual units shown in FIG. 4 to differentiate between the data area, which is a rewritable area, and the header area, which is an embossed area.

The playback decoding processing of each unit, the processing being switched depending on the area switching signal, will now be described in detail.

### 3) Offset Control Circuit, Asymmetry Control Circuit, and Equalization-Coefficient Learning Circuit

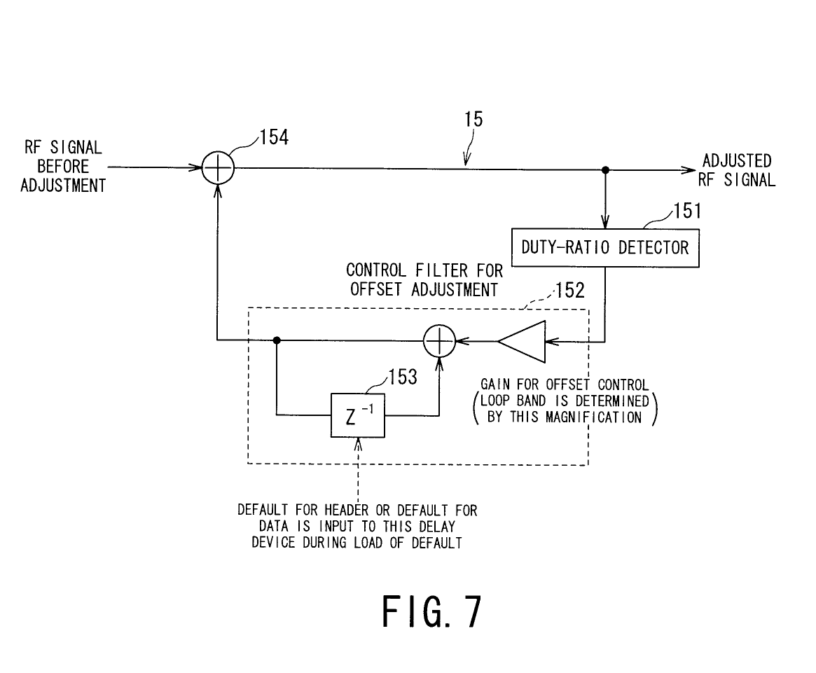

FIG. 7 is a diagram showing an example of a detailed configuration of the offset control circuit 15. In the offset control circuit 15, a duty-ratio detector 151 detects the duty ratio of the playback signal, and the adder 154 performs addition/subtraction to adjust the amount of offset (a filter value) of an input signal through a feedback loop so that the duty ratio becomes constant, for example, 50%.

The feedback loop has a control filter 152 for the offset adjustment. For each clock, the control filter 152 updates the amount of offset (a filter value) stored in a delay device 153, which is implemented with a resistor or the like.

Since signals input to the offset control circuit 15 for the header area and the data area are different from each other, the default of the amount of offset (the filter value) of the delay device 153 is re-reset during the switching between the header area and the data area. The setting of the defaults is performed based on the area switching signal.

Predetermined fixed values may be used as the defaults. Alternatively, the amount of offset (the filter value) obtained when the processing is completed last time may be stored in an appropriate memory for use as each default.

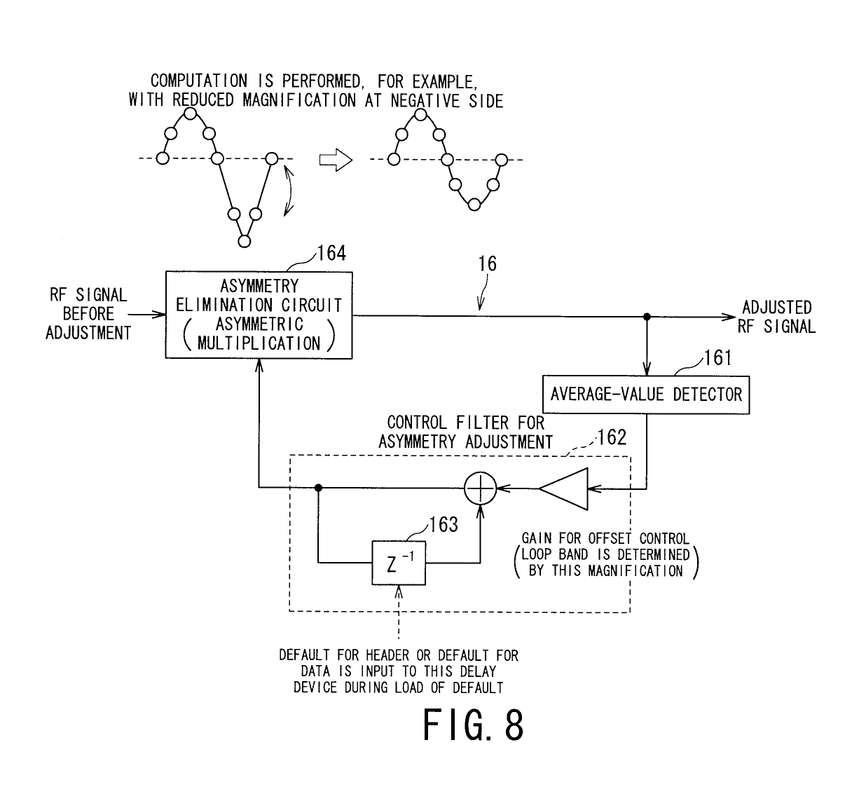

FIG. 8 shows an example of a detailed configuration of the asymmetry control circuit 16. In the asymmetry control circuit 16, an average-value detector 161 detects, for example, an average value of the playback signal, and an asymmetry elimination circuit 164 eliminates an asymmetry of the waveform of an input signal through a feedback loop so that the average value approaches zero. For example, when the average value is negative, the asymmetry elimination circuit 164 performs adjustment so that the positive and negative waveforms become symmetric by multiplying such a coefficient that reduces the amplitude of a negative portion of the input waveform.

The feedback loop has a control filter 162 for the asymmetry adjustment. In the same manner as the offset control circuit 15, for each clock, the control filter 162 updates an adjustment value (a filter value) stored in a delay device 163, which is implemented with a resistor or the like.

Also, in this case, since signals input to the asymmetry control circuit 16 for the header area and the data area are different each other, the default of the adjustment value (the filter value) of the delay device 163 is reset during the switching between the header area and the data area. The setting of the default is performed based on the area switching signal.

Predetermined fixed values may be used as the defaults. Alternatively, the adjustment value (the filter value) obtained when the processing is completed last time may be stored in an appropriate memory for use as each default.

The equalization-coefficient learning circuit 24 in the limit-equalizer/adaptive-equalizer 22 also employs a similar control filter to update its filter value for each clock. More specifically, the filter coefficients c1, c2, c3 are updated in registers 209, 210, and 211. The defaults of the filter values also need to be set when the switching is performed from the header area to the data area and the adaptive equalization processing is started. The area switching signal is used to determine the timing of the setting. In this case as well, predetermined fixed values may be used as the defaults, or the last value of the previous adaptive equalization may be used as the defaults.

### 4) Limit-Equalizer/Adaptive-Equalizer

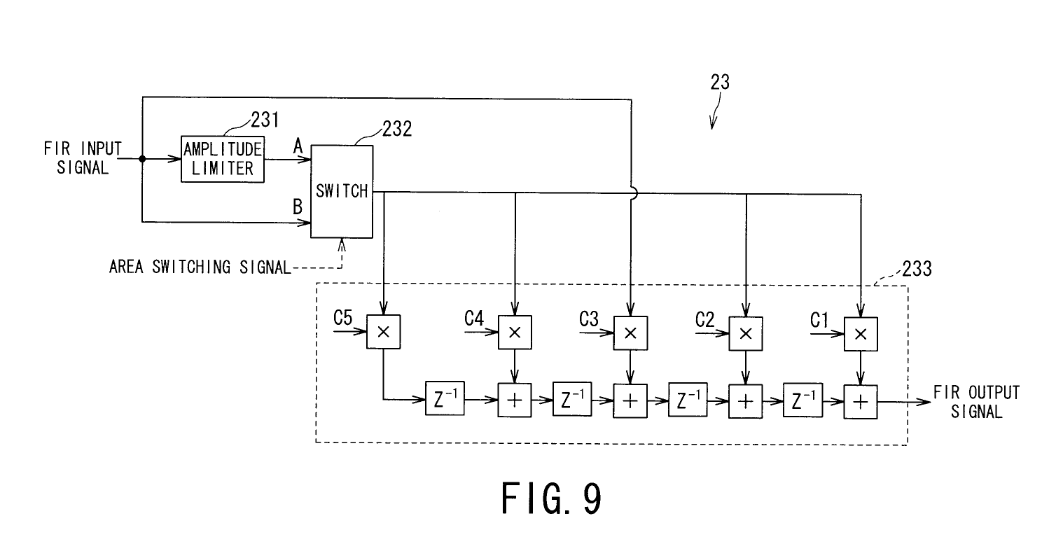

FIG. 9 is a diagram showing an example of a detailed configuration of the limit-equalizer/adaptive-equalizer 22 according to the present embodiment and particularly illustrating the configuration of the limiter-equipped FIR filter 23 therein. The limiter-equipped FIR filter 23 includes an amplitude limiter 231, a switch 232, and a digital filter main-unit 233.

In general, a digital filter can be configured as a standard digital filter or as a inverted digital filter. The standard digital filter has a delay circuit at the input end of multipliers (e.g., the configuration shown in FIG. 5), while the inverted digital filter has a delay circuit at the output end of multipliers. The standard digital filter and the inverted digital filter can be equivalently converted each other.

The digital filter main-unit 233 has a configuration of the inverted digital filter. With this configuration, a filter serving as a limit equalizer and a filter serving as an adaptive equalizer are achieved by the same circuit configuration.

For playback of the data area, the switch 232 selects an input B. As a result of this selection, the input signal is directly input to the digital filter main-unit 233. In this case, the values output from the equalization-coefficient learning circuit 24 are used as the coefficients for the multipliers.

On the other hand, for playback of the header area, the switch 232 selects an input A. As a result of this selection, a signal whose amplitude was limited by the amplitude limiter 231 is input to the digital filter main-unit 233. In this case, however, an input signal whose amplitude is not limited is directly input to only the center tap in the digital filter main-unit 233. The coefficients for the multipliers are switched over to predetermined coefficients for the limit equalizer.

The limit equalizer itself is of known technology, details of which are not thus described herein, and the use of the configuration (shown in FIG. 9) having the limiter prior to the high-pass-boost digital filter allows the high-frequency signal amplitude of 3T or the like to be boosted without causing an increase in the amount of jitter due to noise. The filter configuration, therefore, is effectively used for the digital slice system.

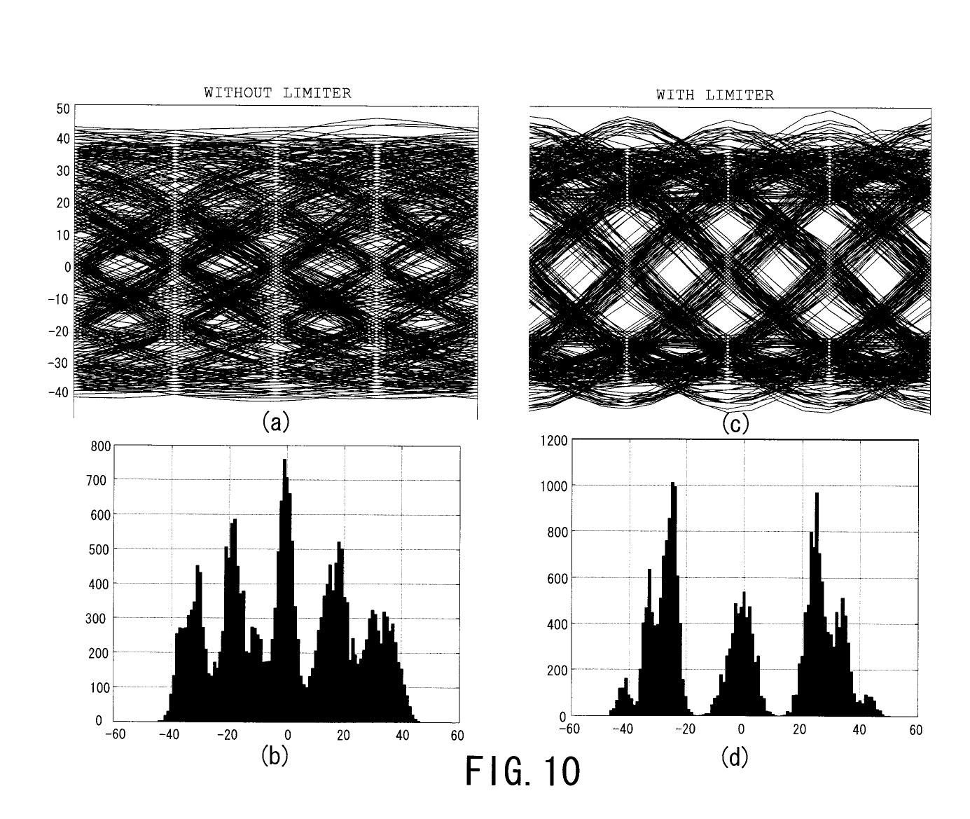

FIG. 10 illustrates an effect of the limit equalizer. Part (a) of FIG. 10 shows an eye pattern of the playback signal in the absence of the limiter, and part (b) of FIG. 10 is an amplitude histogram of the playback signal.

Part (c) of FIG. 10 shows an eye pattern of the playback signal in the presence of the limiter-equipped equalizer according to the present embodiment, and Part (d) of FIG. 10 is an amplitude histogram of the playback signal.

As can be seen from FIG. 10, when the equalizer is configured as the limiter equalizer, the amount of jitter is reduced and the limit equalizer is thus effective for the digital slice system.

As described above, the limiter-equipped FIR filter 23 employs the same circuit configuration to function, during playback of the header area, as a limiter-equipped equalizer suitable for the digital slice system and to function, during playback of the data area, as an adaptive equalization filter suitable for the PRML system.

### 5) Slicer/Viterbi Decoder

The slicer/viterbi decoder 26 also switches between the decoding system for the header area and the decoding system for the data area, in response to the area switching signal.

Viterbi decoding processing corresponding to the PRML system is performed for decoding of the data area, Since the Viterbi processing is of known technology, the description thereof is not given herein.

The digital slice system is used for decoding of the header area to provide binary data by determining “1” and “0” based on, for example, whether or not the amplitude is greater or smaller than the zero point. In the present embodiment, correction processing based on run-length limitation is further performed on the output binary data to reduce the error rate.

Since the DVD-RAM employs the 8/16 modulation system based on 3T code, signals having 2T or smaller should not be generated. Based on this condition, when a 1T or 2T signal is generated in data digitized by the slice, processing for forcibly correcting the signal into a 3T signal is performed.

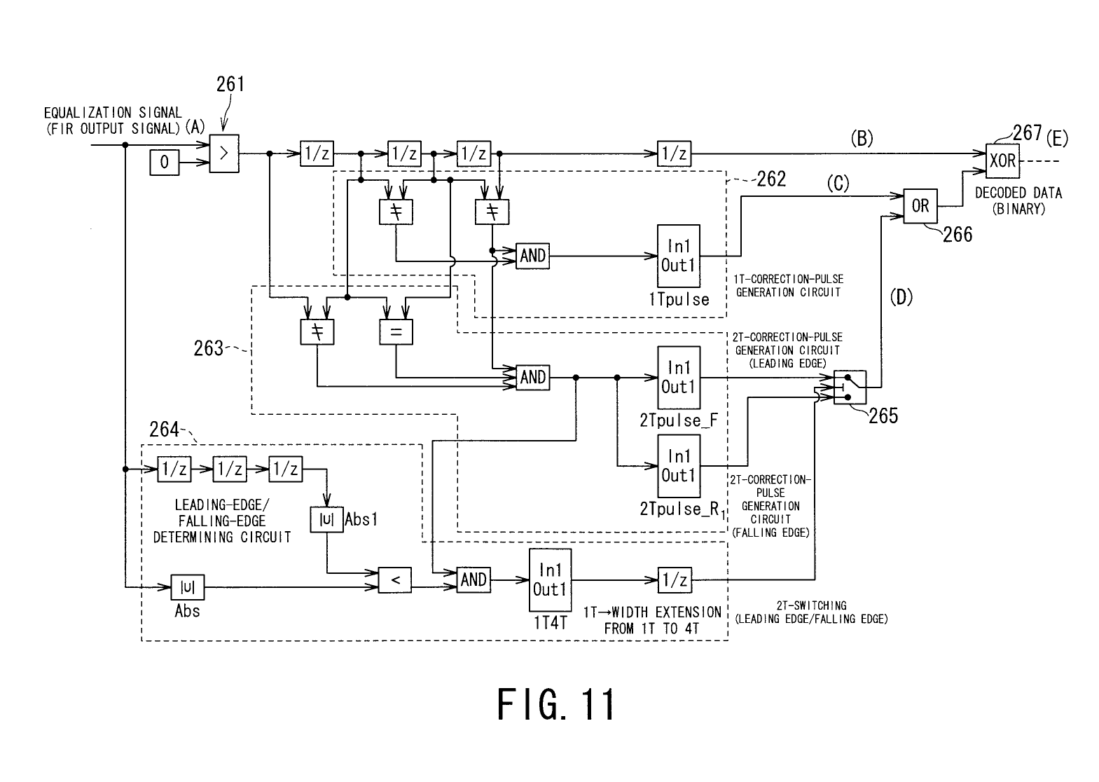

FIG. 11 is an example of a configuration when the slicer/viterbi decoder 26 is caused to function as the digital slice system. This configuration achieves functions including slice processing and correction processing based on the run-length limitation.

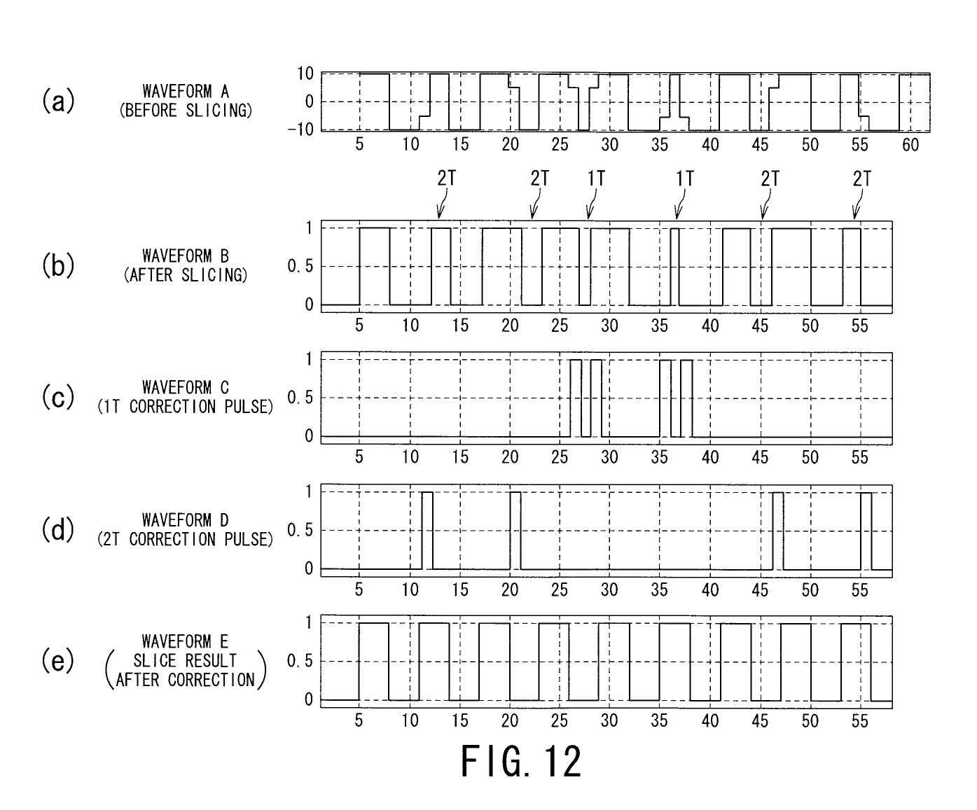

FIG. 12 illustrates waveforms at points A, B, C, D, and E shown in FIG. 11. This is an example of a case in which a 3T sequential pattern is input.

Part (a) of FIG. 12 shows the waveform A of the output of the FIR filter 23 in response to the 3T sequential pattern, the waveform A being multivalued-data waveform before the slicing. Part (b) of FIG. 12 shows the waveform B after the waveform A is sliced. A comparator 261 converts multivalued data into binary data by performing size comparison with zero to thereby provide the waveform B. Due to the influence of jitter resulting from noise or the like, the waveform B contains 1T and 2T, which are not supposed to be contained.

A 1T-correction-pulse generation circuit 262 shown in FIG. 11 generates a 1T correction pulse (the waveform C) shown in part (c) of FIG. 12. That is, the 1T-correction-pulse generation circuit 262 detects 1T contained in the waveform B after slicing, and generates two 1Ts for the front side and rear side of the center of the detected 1T to generate the waveform C of the 1T correction pulse.

A 2T-correction-pulse generation circuit 262 generates a 2T correction pulse (the waveform D) shown in part (d) of FIG. 12. In the case of 2T, 1T is added to either the front side or rear side thereof to forcibly convert 2T into 3T, and in this case, a more likely edge is estimated based on the amplitude information of the input signal. The estimation is performed by a leading-edge/trailing-edge determining circuit 264, and the switch 265 is operated based on a result of the estimation.

An OR circuit 266 obtains the OR of the 1T correction pulse (the waveform C) and the 2T correction pulse (the waveform D), and an XOR circuit 267 then obtains the exclusive OR of the resulting signal and the waveform B before the correction to obtain the corrected waveform E shown in part (e) of FIG. 2.

The corrected waveform E has a 3T sequential pattern from which all erroneous detection of 1T and 2T is removed.

As described above, the slicer/viterbi decoder 26 according to the present invention performs correction based on the run-length limitation to reduce the amount of erroneous detection for the digital slice system.

### 6) Phase Comparator, Etc.

In some cases, the phase of sampling points of multivalued data must be shifted by a half clock, during switching between when Viterbi decoding processing is used to obtain binary data from multivalued data and when digital slice processing is used to obtain binary data from multivalued data.

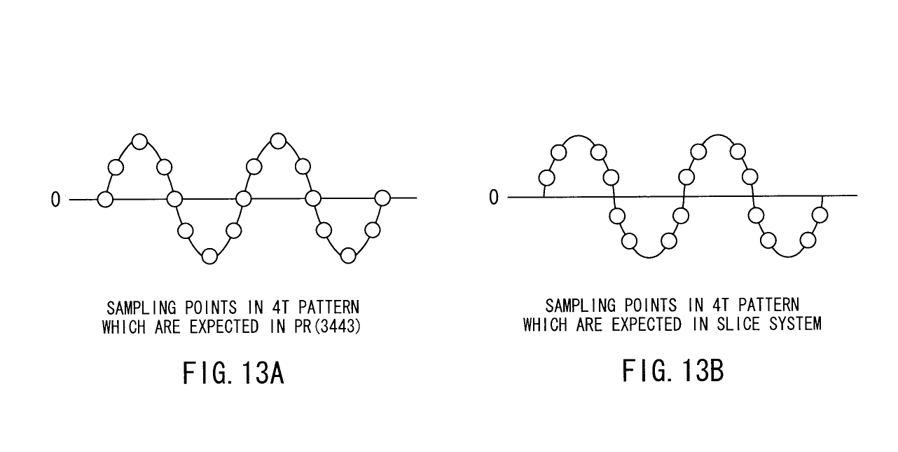

FIGS. 13A and 13B show a 4T pattern together with sampling points (indicated by circles) when the partial response class is PR(3443).

In this case, it is assumed that, in the Viterbi decoding processing, sampling is performed so that sampling points in a 4T pattern cross the zero point, as shown in FIG. 13A.

On the other hand, it is assumed, in the digital slice processing, sampling is performed so that sampling points in a 4T pattern become symmetric with respect to the zero point, as shown in FIG. 13B.

That is, the phase of expected sampling points in the Viterbi decoding processing and the phase of expected sampling points in the digital slice processing are shifted from each other by a half clock.

For switching between the playback decoding processing for the header area using the digital slice system and the playback decoding processing for the data area using the PRML system, the phase of the sampling points needs to be shifted by a half clock.

The shifting can be achieved by switching the phase detection methods for the phase comparator 18. For example, switching from a system using a zero-cross phase comparator (ZPD) for performing control using the zero point as a phase stable point to a system using a non-zero-cross phase comparator allows the phase of the sampling points of the AD converter 14 to be shifted by a half clock (0.5T).

Alternatively, switching the number of FIR-filter taps of the limiter-equipped FIR filter 23 from an odd-number of taps to an even number of taps also allows the phase of the sampling points to be shifted by a half clock. That is, the phase stable point is maintained with an odd-number of taps, whereas the phase is shifted by a half clock (0.5T) with an even-number of taps. In this case, there is no need to change the phase detection method of the phase comparator 18 and, for example, the configuration of the ZPD can be directly changed.

As described above, in the optical-disc recording/playback apparatus 1 and the optical-disc recording/playback method according to the present embodiment, with respect to an optical-disc having a data area serving as a recordable area and a header area in which the address information of the data area is pre-recorded by embossing, both data recorded in the data area and data recorded in the header area can be played back with high quality, without making changes to the basic configuration.

The present invention is not limited to the above-described embodiment, and in actual applications, the present invention can be embodied by modifying the elements thereof without departing from the spirit and scope of the present invention. The elements disclosed in the above-described embodiment can be appropriately combined to realize various modifications. For example, some of the elements illustrated in the embodiment may be eliminated therefrom. In addition, elements in different embodiments may be combined as appropriate.

What is claimed is:

1. An optical-disc recording/playback apparatus for performing recording/playback to/from an optical-disc having a data area serving as a recordable area, and a header area in which address information of the data area is pre-recorded by embossing, the apparatus comprising:
an area determining unit for determining the data area and the header area based on a playback signal from the optical-disc;
an AD converter for converting the playback signal from an analog signal to a digital signal; and
a playback decoding unit for reading information of the data area and the header area from the digital signal output from the AD converter,
wherein, during playback of the data area, the playback decoding unit performs first playback decoding processing, and during playback of the header area, the playback decoding unit performs second playback decoding processing without making changes to a basic configuration of the playback decoding unit.

2. The optical-disc recording/playback apparatus according to claim 1, wherein the first playback decoding processing comprises playback decoding processing based on a PRML system, and the second playback decoding processing comprises playback decoding processing based on a digital slice system.

3. The optical-disc recording/playback apparatus according to claim 2, wherein the playback decoding unit has a digital filter unit that operates as an adaptive equalization filter during the first playback decoding processing and that operates as a limit equalizer during the second playback decoding processing.

4. The optical-disc recording/playback apparatus according to claim 2, wherein the playback decoding unit comprises a decoding unit for converting a multivalued digital signal into binary data, and wherein, during the first playback decoding processing, the decoding unit performs conversion based on viterbi decoding, and during the second playback decoding processing, the decoding unit performs conversion based on slice processing and performs correction based on run-length limitation on a result of the conversion.

5. The optical-disc recording/playback apparatus according to claim 2, wherein the playback decoding unit comprises a phase comparator for phase-locked-loop processing, and a sampling position of a signal input to the phase comparator during the first playback decoding processing and a sampling position of a signal input to the phase comparator during the second playback decoding processing are shifted from each other by a half clock.

6. The optical-disc recording/playback apparatus according to claim 3, wherein during switching between the first playback decoding processing and the second playback decoding processing, when the number of taps of the digital filter unit is an odd number, the number is switched to an even number, and when the number of taps of the digital filter unit is an even number, the number is switched to an odd number.

7. The optical-disc recording/playback apparatus according to claim 1, wherein the playback decoding unit comprises a control filter having a filter value that is changed during switching between the first playback decoding processing and during the second playback decoding processing.

8. The optical-disc recording/playback apparatus according to claim 7, wherein the control filter has a first default for the first playback decoding processing and a second default for the second playback decoding processing, and wherein, during the first playback decoding processing, the filter value is set to the first default, and during the second playback decoding processing, the filter value is set to the second default.

9. The optical-disc recording/playback apparatus according to claim 7, wherein, during the first playback decoding processing, the control filter uses, as a default of the filter value, a value obtained when the first playback decoding processing was performed last time, and during the second playback decoding processing, the control filter uses, as the default of the filter value, a value obtained when the second playback decoding processing was performed last time.

10. An optical-disc recording/playback method for performing recording/playback to/from an optical-disc having a data area serving as a recordable area and a header area in which address information of the data area is pre-recorded by embossing, the method comprising the steps of:
(a) determining the data area and the header area based on a playback signal from the optical-disc;
(b) converting the playback signal from an analog signal to a digital signal; and
(c) playing-back information of the data area and the header area from the digital signal converted in step (b),
wherein, in step (c), during playback of the data area, playing-back based on a PRML system is performed, and during playback of the header area, playing-back based on a digital slice system is performed.
